(19) United States
(12) Patent Application Publication
(10) Pub. No.: US 2008/0187394 A1
(43) Pub. Date: Aug. 7, 2008

(54) External control assembly for quick-release device of linear actuator

(75) Inventor: Wen-Chia Tsou, Taichung (TW)

Correspondence Address: CHARLES E. BAXLEY, ESQ., 90 JOHN STREET, THIRD FLOOR, NEW YORK, NY, 10038, US

(73) Assignee: Hiwin Mikrosystem Corp.

(21) Appl. No.: 11/703,617

(22) Filed: Feb. 6, 2007

(51) Int. Cl. F16D 39/00

(52) U.S. Cl. 403/361; 74/125.5; 74/100.2; 74/105

(57) ABSTRACT

An external control assembly for a quick-release device of a linear actuator comprises a collar and a handle and the purpose of the quick-release device for promptly returning a workpiece driven by the linear actuator can be achieved by implementing the handle to rotate the collar. According to the present invention, the collar has a polygon-shaped out periphery and the handle comprises a assembling hole shaped in a polygon shape corresponding to the out periphery of the collar so that when the handle is mounted onto the out periphery of the collar, a combined motion of simultaneous rotation about the axis of the collar of the handle can be achieved.

### BACKGROUND OF THE INVENTION

1. Technical Field

The present invention relates to linear actuators and, more particularly, to a linear actuator with a ballscrew transmission system. The present invention provides a strategy aimed at improved operational efficiency and convenience of a quick-release device of such linear actuator.

2. Description of Related Art

The function principle of a linear actuator is that, in the main, a screw is rotated by a power source and in turn drives a nut screwed thereon to move a transmission part that carries a workpiece so that the workpiece can be linearly shifted. Such linear actuator can be extensively applied to beds, chairs, tables, vertical translation stages, power windows and so on. The velocity of the linear actuator is subject to the motor speed and the lead of the screw and therefore it takes time for the linear actuator to prepare for the movement of linear extension or contraction. However, the linear actuator is required to perform a quick contraction often and often. For instance, when the bed or chair where the linear actuator applied to is required to promptly return to an initial position thereof, the contracting flight of the linear actuator controlled by the motor and screw is generally inferior to expectation. For remedying this problem, a quick-release device has been equipped to the linear actuator.

One type of the prior quick-release devices related to the present invention implements a constraint spring to constrict the transmission part of the linear actuator so as to retain the transmission part and the nut from revolving relatively so that the object carried by the linear actuator can be secured from gravitating. Whereas, if the constraint spring is diametrically expanded to release the transmission part from constraint, the weight of the workpiece can bear on the transmission part and the nut to make the both promptly gravitate in a revolving motion so as to achieve the objectives of quick contraction of the linear actuator and prompt return of the workpiece. An example of such quick-release device may be U.S. Pat. No. 6,158,295.

A tool for fulfilling foresaid diametrical expansion of the constraint spring is typically a handle. As the appearance of a linear actuator is shown in FIGS. 1 and 2, it can be seen that the foresaid spring is settled a collar 10 and a handle 15 is mounted around the collar 10 in the manner that the spring can be diametrically expanded by rotating the handle 15 and the collar 10 along a predetermined direction. Thus, the collar 10 and the handle 15 are jointly called as an external control assembly for the quick-release device.

The collar 10 has a round-sectioned shape and the handle 15 has an opened annular assembling portion 16 that defines a round hole 17 therein for being mounted onto the out periphery of the collar 10. For securing the round hole 17 with respect to the collar 10, two screws 18 are arranged at the opening 16 to constricted the round hole 17 so that the round hole 17 and the collar 10 can be tightly combined in virtue of the friction between the round hole 17 and the collar 10. However, one problem with such a strategy is that the radically tightened screws 18 can induce plastic deformation of the handle 15 and in turn lead the handle 15 to break due to stress concentration. Another problem with such a strategy is that an auxiliary tool, such as a screwdriver, is required to tighten or loosen the screws 18 for adjusting the angle of the handle 15 and this is inconvenient to a user. One more problem with such a strategy is that the combining relationship between the round hole 17 and the collar 10 in virtue of the friction therebwtween is instable and the handle 15 may not easily and efficiently drive the collar 10 to rotate. Thus, the state that the handle 15 revolves in vain but the collar 10 stays still can frequently occur.

### SUMMARY OF THE INVENTION

The present invention has been accomplished under these circumstances in view. It is the objective of the present invention to remedy the problem with the external control assembly for the quick-release device of a linear actuator.

To achieve these and other objectives of the present invention, the present invention implements a collar having a polygon-sectioned shaped out periphery and a handle comprising an assembling portion with an assembling hole shaped in a polygon-sectioned shape for being fittingly mounted onto the out periphery of the collar. Lying on said structure, a reinforcement rib is further arranged on the assembling portion, and a retaining recess and retaining rib are provided.

The foresaid resolution according to the present invention achieves a combined motion of simultaneous rotation about the axis of the collar of the handle and the collar so that the handle can easily and efficiently drive the collar to rotate.

The foresaid resolution according to the present invention allows a user to handily, easily and promptly assemble the handle and collar with his bare hands.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a plane view of a linear actuator and particularly illustrating a quick-release handle assembled around a collar of a quick-release device according to prior arts;

FIG. 2 is a perspective drawing depicting the quick-release handle assembled around the collar of a quick-release device according to prior arts;

FIG. 3 is a plane view of a linear actuator and particularly illustrating the quick-release handle of the present invention assembled around an ameliorated collar of a quick-release device according to the present invention;

FIG. 4 is an exploded drawing showing the quick-release handle and the ameliorated collar according to the present invention;

FIG. 5 is an assembly drawing showing the quick-release handle and the ameliorated collar according to the present invention; and

FIG. 6 is sectional view taken along line 6-6 of FIG. 5.

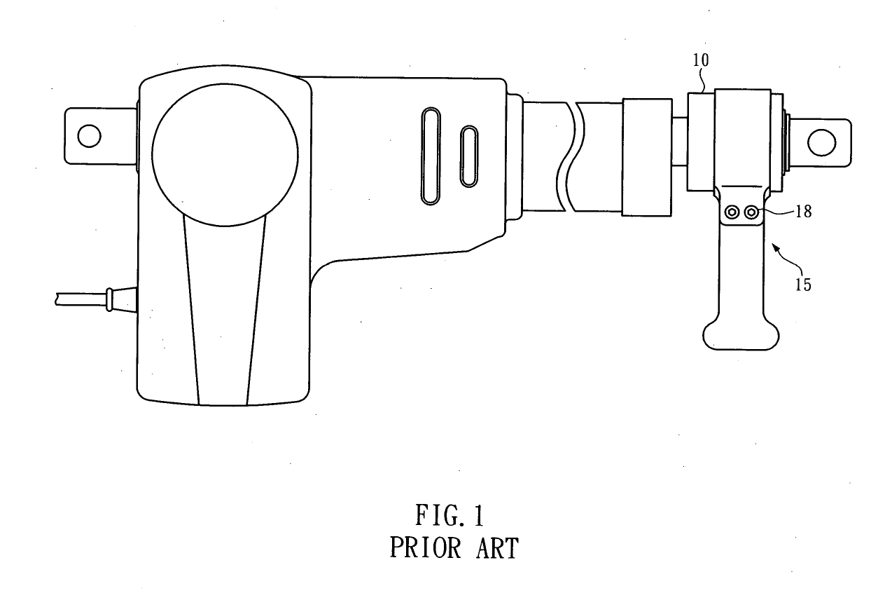

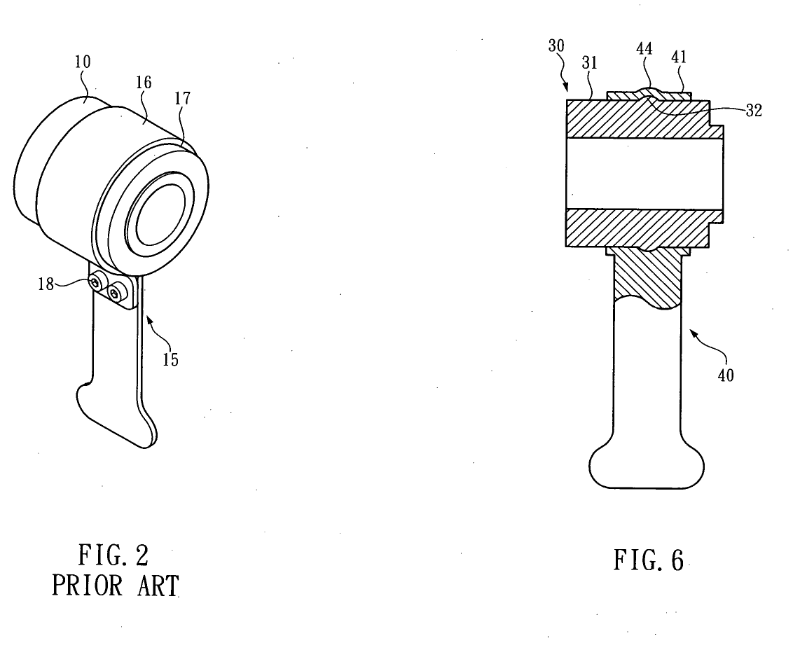

### DETAILED DESCRIPTION OF THE PREFERRED EMBODIMENT

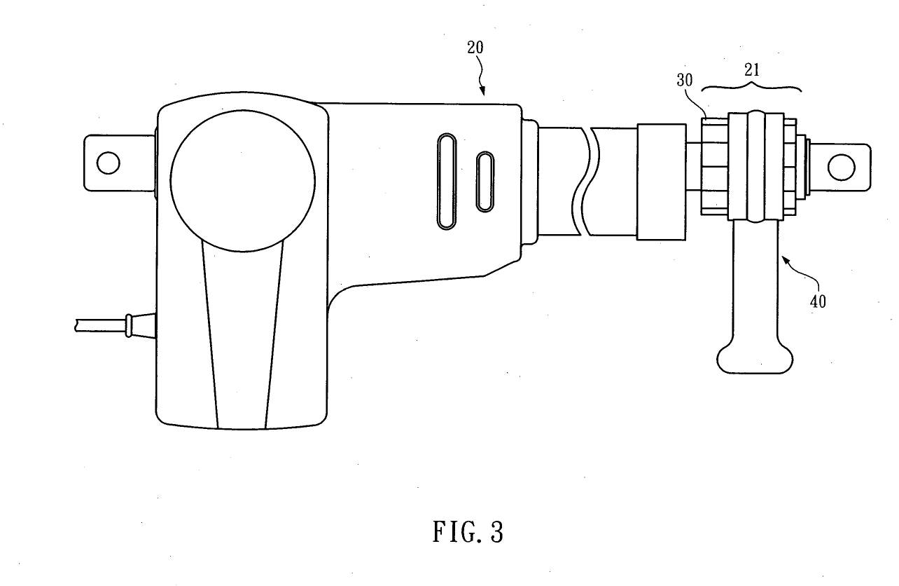

In FIG. 3, a plane view of a conventional linear actuator 20 with a ballscrew transmission system is provided. Nevertheless, the quick-release device 21 of the linear actuator 20 comprises an ameliorated collar 30 and a handle 40 for driving the collar 30. The collar 30 and handle 40 jointly compose an external control assembly of the quick-release device 21. As discussed previously, the quick-release device 21 generally implements a constraint spring to constrict the transmission part of the linear actuator so as to retain the transmission part and the nut from revolving relatively so that the object carried by the linear actuator can be secured from gravitating. Whereas, if the constraint spring is diametrically expanded to release the transmission part from constraint, the weight of the workpiece can bear on the transmission part and the nut to make the both promptly gravitate in a revolving motion so as to achieve the objectives of quick contraction of the linear actuator and prompt return of the workpiece. The foresaid constraint spring is deposited in the collar 30 in FIG. 3 and the foresaid handle 40 can be assembled onto the collar 30 so that the constraint spring can be diametrically expanded by rotating the collar 30 and the handle 40 along a predetermined direction.

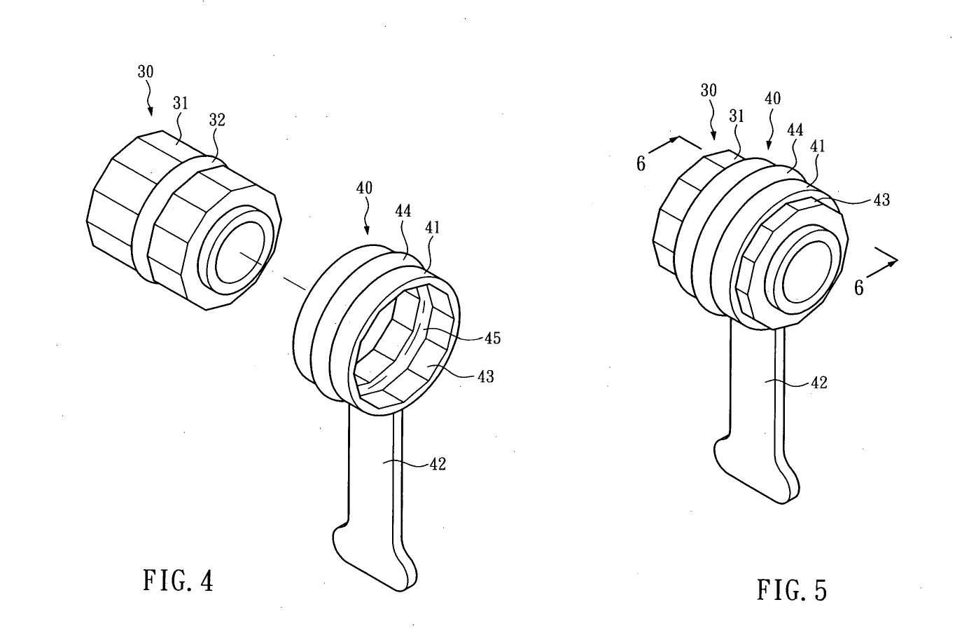

FIGS. 4 and 5 are respectively an exploded view and an assembly drawing of the disclosed handle 40 and the ameliorated collar 30. Specially, the collar 30 has a regular-polygon-shaped out periphery 31 and the handle 40 has an assembling portion 41 and a gripping portion 42 integrated with and extended from the assembling portion 41 wherein the assembling portion 41 comprises a assembling hole 43 shaped in a regular-polygon shape corresponding to the out periphery 31 of the collar 30. Thus, when the assembling hole 43 of the handle 40 assembled onto the out periphery 31 of the collar 30, due to the matching regular-polygon shapes thereof, by rotating the handle 40 about the axis of the collar 30 for a determined angle, the collar 30 can be successively driven to rotate.

The purpose of rotating the collar 30, just alike that of the prior arts, is to diametrically expand a constraint spring positioned in the collar 30 to release the transmission part of the linear actuator from constraint so that the weight of the workpiece can bear on the transmission part and the nut to make the both promptly gravitate in a revolving motion so as to achieve the objectives of quick contraction of the linear actuator and prompt return of the workpiece

Again, according to FIGS. 4 and 5, a reinforcement rib 44 is further arranged around the periphery of the assembling portion 41 of the handle 40 for enhancing the structural strength of the assembling portion 41. Besides, a retaining rib 32 is provided around the out periphery 31 of the collar 30 while a retaining recess 45 is provided around the inner wall of the assembling hole 43. As the collar 30 and the handle 40 are both made of plastic material, when the handle 40 is assembled onto the collar 30, the mutual compression therebetween leads the retaining rib 32 to be retained in the retaining recess 45, as shown in FIG. 6. Thereby, the handle 40 can be properly positioned and secured against slipping away from the collar 30 along the direction parallel to the axis of the collar 30.

To sum up, the advantages of the structure of the disclosed subject matter includes that the collar 30 provides the regular-polygon-shaped out periphery 31 and the handle 40 provides matching regular-polygon-shaped assembling hole 43 so that when the both are assembled, as the combined motion of simultaneous rotation about the axis of the collar 30 thereof is achieved, the handle 40 can easily and efficiently drive the collar 30 to rotate. Moreover, the disclosed handle 40 is formed in an integral piece and has the reinforcement rib 44 that facilitates enhancing structural strength. The mutual retaining relation between the retaining rib 32 and the retaining recess 45 helps to prevent the handle 40 from slipping away from the collar 30 along the direction parallel to the axis of the collar 30. Thereby, without the need of any screw component, the secure assembly of the handle and collar can be accomplished.

The advantage of the disclosed subject matter in use is that a user can simply mount the handle 40 onto the collar 30 with the assembling hole 43. Thus, the assembly can be handily, easily, and promptly assembled with the user's bare hand without the need of other tools. By this advantage, the user can conduct repeated experimental assembling operations to determine the optimum extending direction of gripping portion 42 of the handle 40 conforming to the surrounding environment that facilitates the user's operating the gripping portion.

Although a particular embodiment of the invention has been described in detail for purposes of illustration, it will be understood by one of ordinary skill in the art that numerous variations will be possible to the disclosed embodiments without going outside the scope of the invention as disclosed in the claims.

What is claimed is:

1. An external control assembly for a quick-release device of a linear actuator that has a quick-release device for a purpose of promptly returning a workpiece driven by the linear actuator to an initial position wherein the quick-release device has the external control assembly primarily composed of a collar and a handle and the said purpose of the quick-release device can be achieved by implementing the handle to rotate the collar wherein:
the collar has a regular-polygon-shaped out periphery;
the handle has an assembling portion and a gripping portion integrated with and extended from the assembling portion wherein the assembling portion comprises a assembling hole shaped in a regular-polygon shape corresponding to the out periphery of the collar and the handle is mounted onto the out periphery of the collar with the assembling hole;
a reinforcement rib is arranged on the out surface of the assembling portion of the handle for enhancing the structural strength of the assembling portion; and
a retaining rib and a retaining recess that can be retained mutually are respectively provided on the out periphery of the collar and the inner wall of the assembling hole.

2. The external control assembly of claim 1, wherein the out periphery of the collar and the assembling hole of the handle are shaped in matching regular-polygon shapes.

3. The external control assembly of claim 1, wherein reinforcement rib is arranged around the out surface of the assembling portion of the handle in annularity.

4. The external control assembly of claim 1, wherein the retaining rib and the retaining recess are arranged respectively around the out periphery of the collar and the inner wall of the assembling hole in annularity.
